(19) United States
(12) Patent Application Publication
(10) Pub. No.: US 2023/0144332 A1
(43) Pub. Date: May 11, 2023

(54) TECHNOLOGY TO AUTOMATICALLY CONDUCT SPEED SWITCHING IN PROCESSOR LINKS WITHOUT WARM RESETS

(71) Applicant: INTEL CORPORATION, Santa Clara, CA (US)

(72) Inventors: KEVIN YUFU LI, Shanghai (CN); Zhenfu CHAI, Shanghai (CN); Shijie LIU, Shanghai (CN); Zhiguo DENG, Shanghai (CN); Fei WANG, Jiangsu (CN)

(21) Appl. No.: 17/905,229

(22) PCT Filed: Apr. 1, 2020
(86) PCT No.: PCT/CN2020/082676

§ 371 Date: Aug. 29, 2022

(51) Int. Cl. G06F 11/34; G06F 13/36; G06F 9/4401

(52) U.S. Cl. CPC G06F 11/3428; G06F 13/36; G06F 9/4403

(57) ABSTRACT

Systems, apparatuses and methods may provide for technology that detects, by a remote processor coupled to a remote socket, a transition request from a system processor coupled to a system socket, wherein the system socket has an indirect link with the remote socket. The technology may also automatically conduct an operational speed transition at the remote socket in response to the transition request, wherein the operational speed transition at the remote socket is to occur in parallel with a plurality of operational speed transitions at a corresponding plurality of peer sockets.

### TECHNICAL FIELD

Embodiments generally relate to speed switching in processor links. More particularly, embodiment relate to technology that automatically conducts speed switching in processor links without warm resets.

### BACKGROUND

Modem computing systems may contain multiple processors mounted into sockets, where the ports of the processor sockets are interconnected via communication links in various topologies (e.g., ring, chain, pin-wheel). The operating speed of the ports typically starts off relatively slow due to physical layer limitations. Increasing the operating speed of the ports, however, may result in link failures and/or redundant training, particularly when the socket topology is complex.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a socket topology according to an embodiment;

FIG. 2 is a block diagram of an example of a hop state tree according to an embodiment;

FIG. 3 is a block diagram of an example of a transition request sequence according to an embodiment;

FIG. 4 is a block diagram of an example of a training procedure configuration according to an embodiment;

FIG. 5 is a flowchart of an example of a method of operating a system processor according to an embodiment;

FIGS. 6A-6C are flowcharts of examples of methods of operating a processor coupled to a port according to an embodiment;

FIG. 7 is a block diagram of an example of a performance-enhanced computing system according to an embodiment;

FIG. 8 is an illustration of an example of a semiconductor package apparatus according to an embodiment;

FIG. 9 is a block diagram of an example of a processor according to an embodiment; and

FIG. 10 is a block diagram of an example of a multi-processor based computing system according to an embodiment.

### DESCRIPTION OF EMBODIMENTS

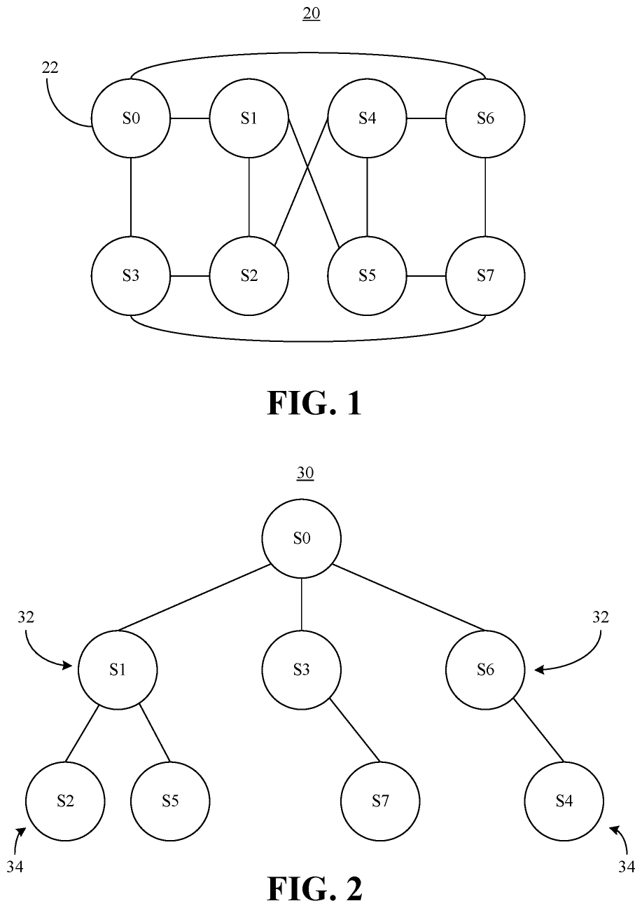

Turning now to FIG. 1, a socket topology 20 is shown in which a first socket 22 (e.g., “system” socket “S0”) is coupled to a plurality of additional sockets (e.g., “peer” sockets “S1” to “S7”) in a multi-socket computing system. In the illustrated example, the peer sockets include “remote” sockets “S2,” “S5,” “S4,” and “S7,” which have an indirect (e.g., “multi-hop”) link with the first socket 22. More particularly, the remote socket S2 has a two-hop link with the first socket 22 through the peer sockets “S1” and “S3,” the remote socket “S5” has a two-hop link with the first socket 22 through the peer socket S1, and so forth. A processor (e.g., host processor, graphics processor, not shown) may be mounted and/or plugged into each socket in the topology 20. For example, a “system” processor might be mounted into the first socket 22, a “remote” processor may be mounted into the remote socket S2, and so forth.

In an embodiment, all of the sockets in the topology 20 operate at the same speed. Moreover, the links between the sockets may be started in a slow mode and subsequently increased to faster modes during the boot processor or at runtime. As will be discussed in greater detail, speed transition requests (e.g., tasks) may be dispatched from the first socket 22 to the peer sockets in a manner that enables operational speed (e.g., frequency) transitions to be conducted at the first socket 22 and the additional sockets in parallel and without involving a warm reset (e.g., including security, link initialization, memory discovery and networking link training). Accordingly, performance may be enhanced through fewer link failures and faster operational speed transitions. Moreover, the use of information about the socket topology 20 to selectively trigger link training procedures may further enhance performance.

FIG. 2 shows a hop state tree 30 for the socket topology 20 (FIG. 1), already discussed. In the illustrated example, the hop state tree 30 includes a set of one-hop nodes 32 (e.g., having direct links to the system socket) and a set of two-hop nodes 34 (e.g., having indirect links to the system socket). In general, an operational speed transition involves a physical layer reset that temporarily breaks the links between sockets. As will be discussed in greater detail, the illustrated system socket S0 dispatches a transition request/task to the set of two-hop nodes 34 before dispatching the transition request/task to the set of one-hop nodes 32. Such an approach enables the set of two-hop nodes 34 to be informed of the operational speed transition before the links between the two-hop nodes 34 and the one-hop nodes 32 are broken. Such an approach reduces link failures, speeds up transitions and enhances performance.

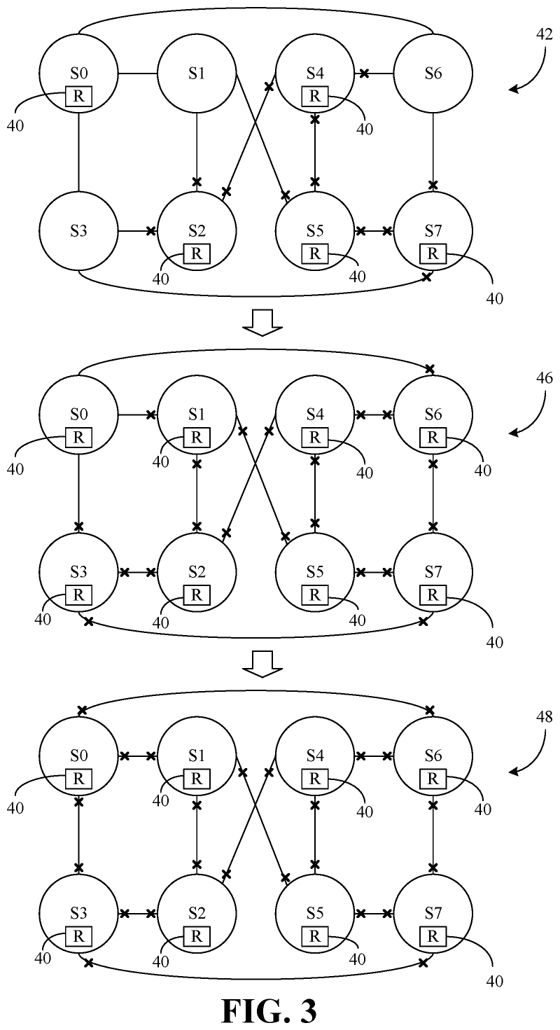

FIG. 3 shows a sequence in which a transition request 40 (“R”) is dispatched from the system socket S0 to the remote sockets S2, S4, S5 and S7 during a first stage 42. In response to detecting the transition request 40, the processors mounted in the remote sockets S2, S4, S5 and S7 initiate an operational state transition that breaks the links at the ports of the remote sockets S2, S4, S5 and S7. For example, the remote socket S2 has one or more ports (e.g., transmit/TX port, receive/RX port) at the link with the peer socket S3 that will be temporarily disconnected during the operational speed transition. The illustrated remote socket S2 also has one or more ports (e.g., TX port, RX port) at the link with the peer socket S1 that will be temporarily disconnected during the operational speed transition.

After the first stage 42, the system socket S0 may dispatch the transition request 40 via direct links to the remaining peer sockets S1, S3 and S6 during a second stage 46. In response to detecting the transition request 40, the processors mounted in the remaining peer sockets S1, S3 and S6 may initiate an operational state transition that breaks the links at the ports of the remaining peer sockets S1, S3 and S6. For example, the remaining peer socket S1 has one or more ports (e.g., TX port, RX port) at the link with the system socket S0 that will be temporarily disconnected during the operational speed transition. The illustrated remaining peer socket S1 also has one or more ports (e.g., TX port, RX port) at the link with the remote socket S2 that will be temporarily disconnected during the operational speed transition.

During a third stage 48, the processor mounted in the system socket S0 may initiate an operational state transition that breaks the links at the ports of the system socket S0. For example, the system socket S0 has one or more ports (e.g., TX port, RX port) at the link with the remaining peer socket S6 that will be temporarily disconnected during the operational speed transition. The illustrated system socket S0 also has one or more ports (e.g., TX port, RX port) at the link with the remaining peer socket S1 that will be temporarily disconnected during the operational speed transition. In an embodiment, the operational speed transitions occur in each of the sockets substantially in parallel (e.g., via synchronization points in the speed transition flow). The illustrated approach therefore enables fewer link failures, faster operational speed transitions and/or enhanced performance.

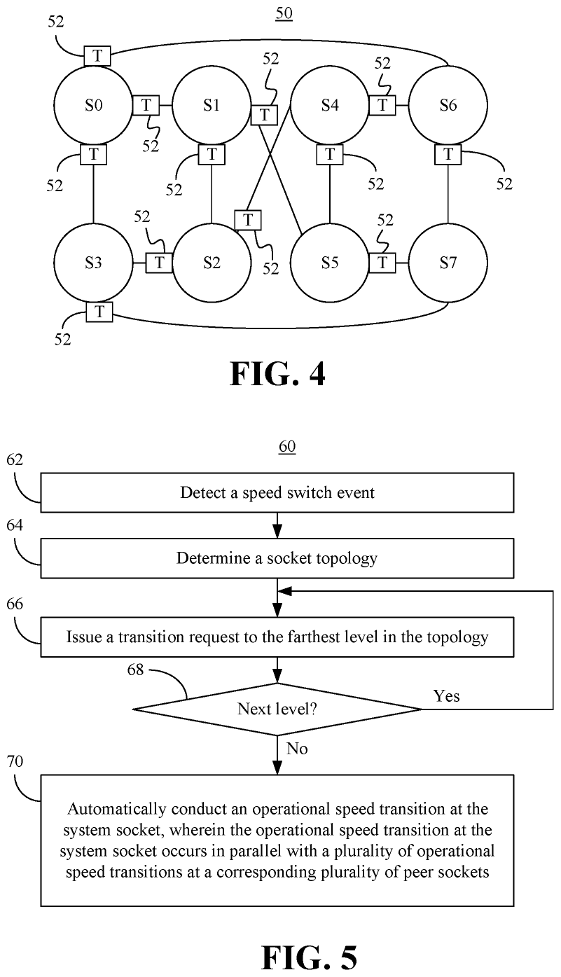

Turning now to FIG. 4, a training procedure configuration 50 is shown. In the illustrated example, the processor mounted into each socket takes into consideration socket identifier (ID) information when determining whether to initiate a training procedure 52 (“T”) on the ports of the socket. More particularly, the training procedure 52 is triggered only when the ID of the socket on the other side of the link is greater than the ID of the socket in question. For example, the system socket S0 initiates the training procedure 52 on the ports at the links with the peer sockets S1, S3 and S6 because each of the IDs S1, S3 and S6 is greater than the ID S0. By contrast, the remote socket S5 may initiate the training procedure only on the ports at the links with the remote socket S7 because the ID S7 is greater than the ID S5 but the IDs S1 and S4 are not greater than the ID S5. Indeed, the illustrated remote socket S7 initiates the training procedure on no ports because the ID S7 is not greater than the IDs S3, S5 or S6. Other socket numbering schemes and/or hierarchies may also be used. The illustrated configuration 50 further enhances performance by eliminating redundant link training (e.g., each link is trained only once per speed transition).

FIG. 5 shows a method 60 of operating a system processor. The method 60 may generally be implemented in a system processor mounted in a system socket such as, for example, the first socket 22 (FIG. 1), already discussed. More particularly, the method 60 may be implemented as one or more modules in a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 60 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 62 provides for detecting a speed switch event. The speed switch event may be detected during the boot time and/or the runtime of a computing system containing the system processor. Moreover, the speed switch event may be associated with an on demand and/or scheduled change in operating frequency that improves performance (e.g., via a speed/frequency increase), saves power (e.g., via a speed/frequency decrease), and so forth. Block 64 determines a socket topology such as, for example, the hop state tree 30 (FIG. 3), already discussed. In an embodiment, a transition request (e.g., task) is issued at block 66 to the farthest level (e.g., most hops) in the topology. Thus, if the greatest number of hops in the topology is two hops, illustrated block 66 would issue the transition request to all of the two-hop sockets on the first pass. A determination may be made at block 68 as to whether there is a next farthest level in the topology. If so, block 66 is repeated for the next farthest level.

Block 70 automatically conducts an operational speed transition at the system socket, wherein the operational speed transition at the system socket occurs in parallel with a plurality of operational speed transitions at a corresponding plurality of peer sockets. Dispatching the transition request as shown reduces link failures by ensuring that indirectly-linked sockets are notified of the impending speed transition before the links to those sockets are disconnected. The illustrated method 60 also enhances performance by bypassing a warm reset of the system processor.

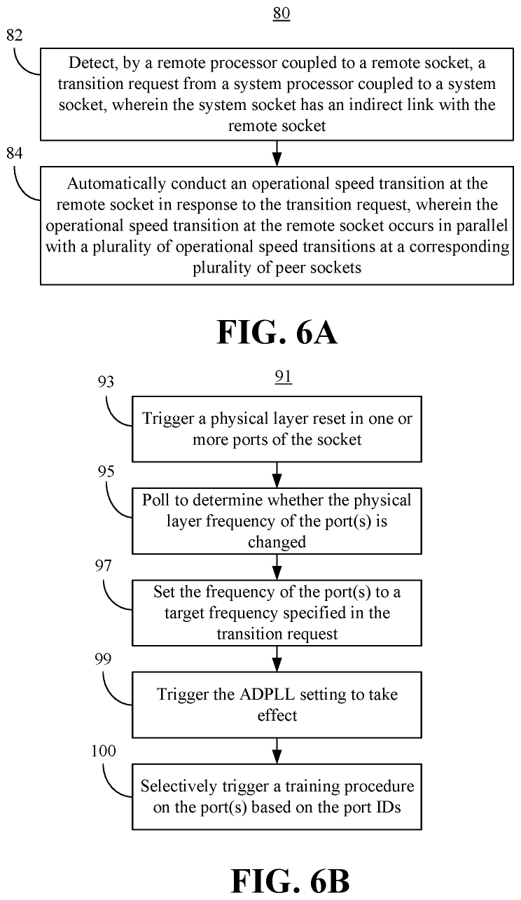

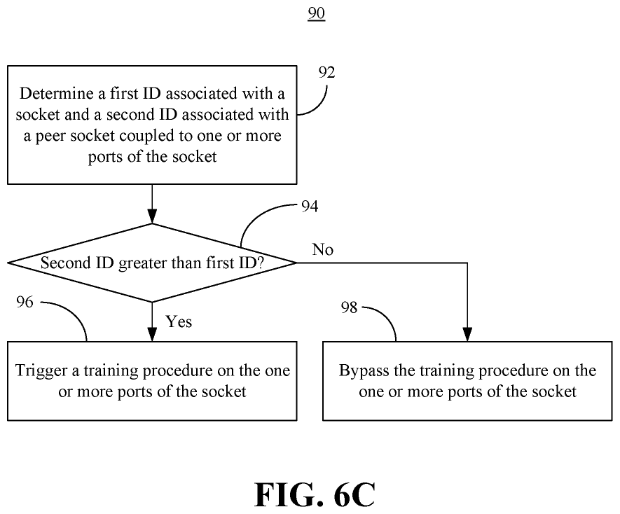

FIG. 6A shows a method 80 of operating a remote processor coupled to a remote socket. The method 80 may generally be implemented in a processor coupled to a remote socket such as, for example, any of the remote sockets S2, S4, S5 and S7 (FIG. 1), already discussed. More particularly, the method 80 may be implemented as one or more modules in a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof.

Illustrated processing block 82 provides for detecting, by the remote processor coupled to the remote socket, a transition request (e.g., task) from a system processor coupled to a system socket, wherein the system socket has an indirect link with the remote socket. In an embodiment, the transition request specifies a target frequency. Block 84 automatically conducts an operational speed transition at the remote socket in response to the transition request, wherein the operational speed transition at the remote socket occurs in parallel with a plurality of operational speed transitions at a corresponding plurality of peer sockets. The illustrated method 80 also bypasses a warm reset of the remote processor. In one example, the indirect link includes at least one of the plurality of peer sockets. Processing the transition request over the indirect link enhances performance through reduced link failures. Moreover, conducting the operational speed transitions in parallel further enhances performance through faster transitions.

FIG. 6B shows a method 91 of operating a processor coupled to a socket. The method 91 may be incorporated into block 84 (FIG. 6A), already discussed. Additionally, the method 91 may generally be implemented in a processor coupled to a remote socket such as, for example, the first socket 22 (FIG. 1) and/or the additional sockets S2-S7 (FIG. 1), already discussed. More particularly, the method 91 may be implemented as one or more modules in a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof.

Illustrated processing block 93 triggers a physical layer reset in one or more ports of the socket. In an embodiment, block 93 does not involve the security, link initialization, memory discovery or network link training operations typically associated with a warm reset. Block 93 may generally result in the links to the port(s) being broken/disconnected. In one example, block 95 polls to determine whether the physical layer frequency of the port(s) is changed, where block 97 may set the phase locked loop (PLL) frequency of the port(s) to the target frequency specified in the transition request. Additionally, illustrated block 99 triggers the analog-input digital PLL (ADPLL) setting to take effect. In an embodiment, block 100 selectively triggers a training procedure on the port(s) based on the port IDs.

FIG. 6C shows another method 90 of operating a processor coupled to a socket. The method 90 may generally be incorporated into block 100 (FIG. 6B), already discussed. Additionally, the method 90 may be implemented in a processor coupled to a socket such as, for example, the first socket 22 (FIG. 1) and/or the additional sockets S2-S7 (FIG. 1), already discussed. More particularly, the method 90 may be implemented as one or more modules in a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof.

Illustrated processing block 92 determines a first ID associated with a socket (e.g., a remote socket) and a second ID associated with a peer socket coupled to one or more ports of the socket. As already noted, a variety of socket numbering schemes and/or hierarchies may be used. In the illustrated example, a determination is made at block 94 as to whether the second ID is greater than the first ID. If so, block 96 triggers a training procedure on the ports of the socket. Otherwise, block 98 bypasses the training procedure on the port(s) of the socket. Thus, the illustrated method 90 enhances performance by eliminating redundant link training.

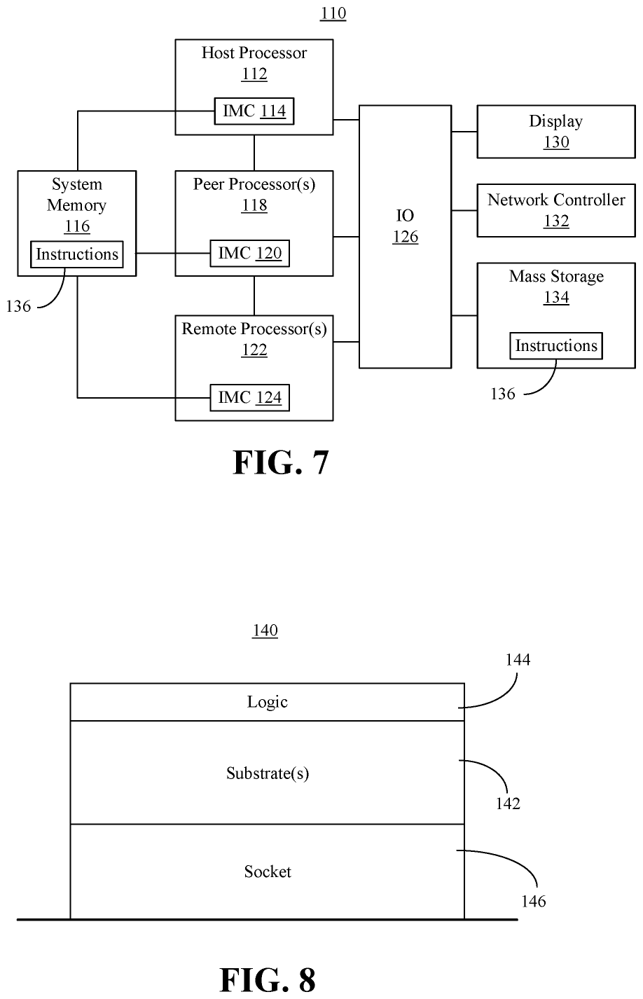

Turning now to FIG. 7, a performance-enhanced computing system 110 is shown. The system 110 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), etc., or any combination thereof.

In the illustrated example, the system 110 includes a host processor 112 (e.g., central processing unit/CPU coupled to a socket, not shown) having an integrated memory controller (IMC) 114 that is coupled to a system memory 116. The illustrated system 110 also includes one or more peer processors 118 (e.g., coupled to one or more sockets, not shown) having an IMC 120 coupled to the system memory 116 and one or more remote processors 122 (e.g., coupled to one or more sockets, not shown) having an IMC 124 coupled to the system memory 116. In an embodiment, an input output (IO) module 126 is coupled to the host processor 112, the peer processor(s) 118, and the remote processor(s) 122. The illustrated IO module 126 communicates with, for example, a display 130 (e.g., touch screen, liquid crystal display/LCD, light emitting diode/LED display), a network controller 132 (e.g., wired and/or wireless), and mass storage 134 (e.g., hard disk drive/HDD, optical disk, solid state drive/SSD, flash memory).

In an embodiment, the host processor 112 executes at least a subset of instructions 136 (e.g., basic input output system/BIOS instructions) retrieved from the system memory 116 and/or the mass storage 134 to perform one or more aspects of the method 60 (FIG. 5), the method 91 (FIG. 6B) and/or the method 90 (FIG. 6C), already discussed. Thus, execution of the subset of the instructions 136 by the host processor 112 may cause the computing system 110 to detect a speed switch event, determine a socket topology, iteratively issue a transition request to the farthest level in the socket topology, and automatically conduct an operational speed transition at a system socket.

Moreover, the remote processor(s) 122 may execute at least a subset of the instructions 136 to perform one or more aspects of the method 80 (FIG. 6A), the method 91 (FIG. 6B) and/or the method 90 (FIG. 6C). Thus, execution of the subset of the instructions 136 may cause the remote processor(s) 122 (e.g., coupled to a remote socket, not shown) to detect, by the remote processor(s) 122, a transition request from the host processor 112 (e.g., coupled to a system socket, not shown), wherein the system socket has an indirect link with the remote socket. Execution of the subset of the instructions 136 may also cause the remote processor(s) 122 to automatically conduct an operational speed transition at the remote socket in response to the transition request, wherein the operational speed transition occurs in parallel with a plurality of operational speed transitions at a corresponding plurality of peer sockets coupled to the peer processor(s) 118.

Additionally, the peer processor(s) 118 may execute at least a subset of the instructions 136 to perform one or more aspects of the method 91 (FIG. 6B) and/or the method 90 (FIG. 6C). Thus, execution of the subset of the instructions 136 may cause the peer processor(s) 118 to trigger a physical layer reset in one or more ports of a socket, poll to determine whether the physical layer frequency of the port(s) is changed, set the frequency of the port(s) to a target frequency specified in the transition request, trigger the ADPLL setting to take effect, and selectively trigger a training procedure on the ports based on the port IDs.

In an embodiment, execution of at least a subset of the instructions 136, further causes the host processor 112, the peer processor(s) 118 and/or the remote processor(s) 122 to determine a first ID associated with a socket and a second ID associated with a peer socket coupled to one or more ports of the socket, trigger a training procedure on the port(s) of the socket if the second ID is greater than the first ID, and bypass the training procedure on the port(s) of the socket if the second ID is not greater than the first ID. The computing system 110 is therefore considered to be performance-enhanced at least to the extent that it experiences fewer link failures, faster operational speed transitions and/or less redundant link training, particularly when relatively complex topologies (e.g., ring, chain, pin-wheel) are used.

FIG. 8 shows a semiconductor apparatus 140 (e.g., chip, die, package). The illustrated apparatus 140 includes one or more substrates 142 (e.g., silicon, sapphire, gallium arsenide) and logic 144 (e.g., transistor array and other integrated circuit/IC components) coupled to the substrate(s) 142. In one example, the substrate(s) 142 are mounted into a socket 146. In an embodiment, the logic 144 implements one or more aspects of the method 60 (FIG. 5), the method 80 (FIG. 6A), the method 91 (FIG. 6B) and/or the method 90 (FIG. 6C), already discussed. Thus, the apparatus 140 is considered to be performance-enhanced at least to the extent that it experiences fewer link failures, faster operational speed transitions and/or less redundant link training.

The logic 144 may be implemented at least partly in configurable logic or fixed-functionality hardware logic. In one example, the logic 144 includes transistor channel regions that are positioned (e.g., embedded) within the substrate(s) 142. Thus, the interface between the logic 144 and the substrate(s) 142 may not be an abrupt junction. The logic 144 may also be considered to include an epitaxial layer that is grown on an initial wafer of the substrate(s) 142.

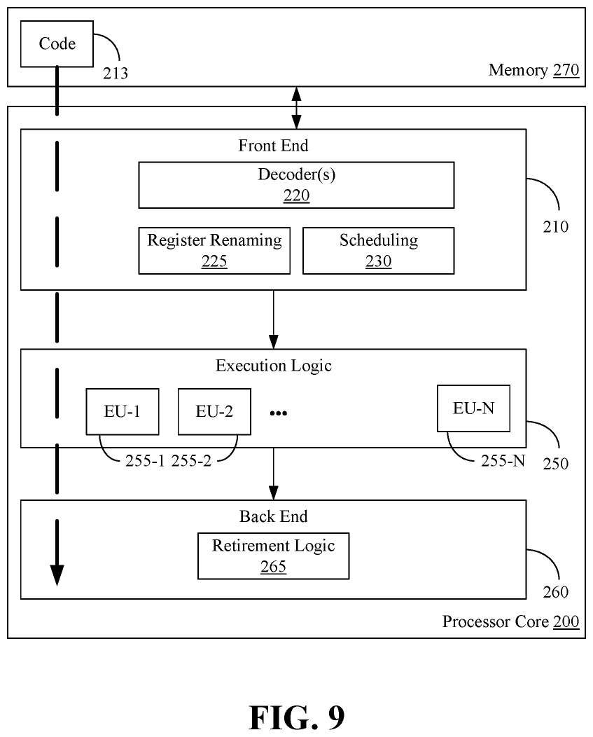

FIG. 9 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 9, a processing element may alternatively include more than one of the processor core 200 illustrated in FIG. 9. The processor core 200 may be a single-threaded core or, for at least one embodiment, the processor core 200 may be multithreaded in that it may include more than one hardware thread context (or “logical processor”) per core.

FIG. 9 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement the method 60 (FIG. 5), the method 80 (FIG. 6A), the method 91 (FIG. 6B) and/or the method 90 (FIG. 6C), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 9, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

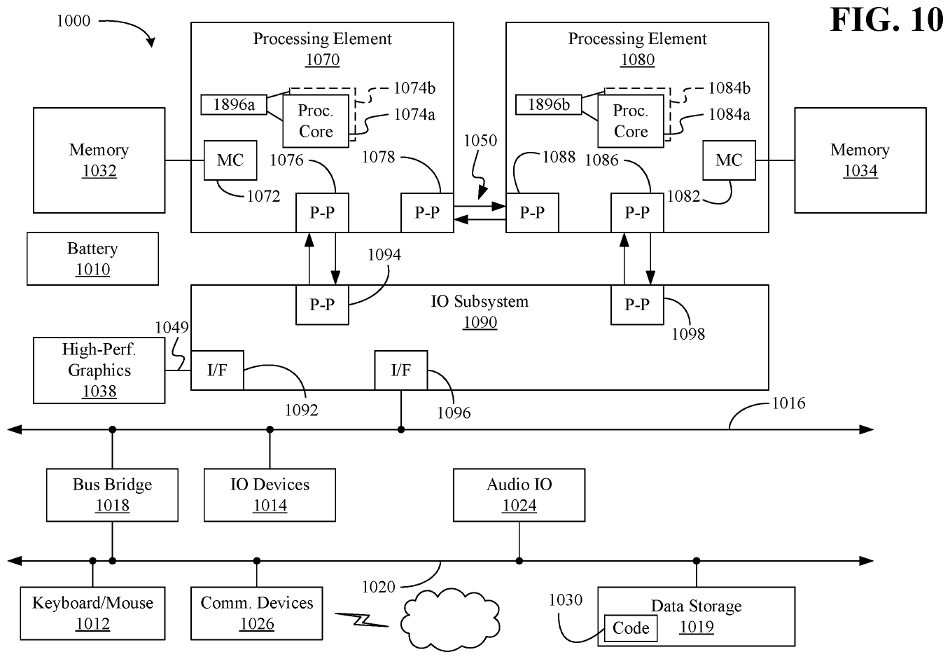

Referring now to FIG. 10, shown is a block diagram of a computing system 1000 embodiment in accordance with an embodiment. Shown in FIG. 10 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 10 may be implemented as a multi-drop bus rather than point-to-point interconnect.

As shown in FIG. 10, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 9.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 10, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 10, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 10, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 60 (FIG. 5), the method 80 (FIG. 6A), the method 91 (FIG. 6B) and/or the method 90 (FIG. 6C), already discussed, and may be similar to the code 213 (FIG. 9), already discussed. Further, an audio I/O 1024 may be coupled to second bus 1020 and a battery 1010 may supply power to the computing system 1000.

Note that other embodiments are contemplated. For example, instead of the point-to-point architecture of FIG. 10, a system may implement a multi-drop bus or another such communication topology. Also, the elements of FIG. 10 may alternatively be partitioned using more or fewer integrated chips than shown in FIG. 10.

Additional Notes and Examples:

Example 1 includes a performance-enhanced computing system comprising a plurality of peer sockets, a remote socket, a remote processor coupled to the remote socket, a system socket having an indirect link with the remote socket, a system processor coupled to the system socket, the system socket to issue a transition request to the remote socket via the indirect link, and a memory comprising a set of executable program instructions, which when executed by the remote processor, cause the remote processor to detect, by the remote processor, the transition request from the system processor and automatically conduct an operational speed transition at the remote socket in response to the transition request, wherein the operational speed transition at the remote socket is to occur in parallel with a plurality of operational speed transitions at the plurality of peer sockets.

Example 2 includes the computing system of Example 1, wherein to conduct the operational speed transition at the remote socket, execution of the instructions causes the remote processor to trigger a physical layer reset in one or more ports of the remote socket, set a frequency of the one or more ports to a target frequency specified in the transition request, and determine whether to trigger a training procedure in the one or more ports based on a first identifier associated with the remote socket and a second identifier associated with a peer socket coupled to the one or more ports.

Example 3 includes the computing system of Example 2, wherein the instructions, when executed, further cause the remote processor to trigger the training procedure on the one or more ports if the second identifier is greater than the first identifier.

Example 4 includes the computing system of Example 2, wherein the instructions, when executed, further cause the remote processor to bypass the training procedure on the one or more ports if the second identifier is less than the first identifier.

Example 5 includes the computing system of any one of Examples 1 to 4, wherein the instructions, when executed, further cause the remote processor to bypass a warm reset of the remote processor.

Example 6 includes the computing system of any one of Examples 1 to 4, wherein the indirect link includes at least one of the plurality of peer sockets.

Example 7 includes the computing system of any one of Examples 1 to 4, wherein the system socket has a direct link with at least one of the plurality of peer sockets, and wherein the system processor is to issue the transition request to the at least one of the plurality of peer sockets via the direct link after issuance of the transition request to the remote socket via the indirect link.

Example 8 includes a semiconductor apparatus comprising one or more substrates, and logic coupled to the one or more substrates, wherein the logic is implemented at least partly in one or more of configurable logic or fixed-functionality hardware logic, the logic coupled to the one or more substrates to detect, by a remote processor coupled to a remote socket, a transition request from a system processor coupled to a system socket, wherein the system socket has an indirect link with the remote socket, and automatically conduct an operational speed transition at the remote socket in response to the transition request, wherein the operational speed transition at the remote socket is to occur in parallel with a plurality of operational speed transitions at a corresponding plurality of peer sockets.

Example 9 includes the semiconductor apparatus of Example 8, wherein to conduct the operational speed transition at the remote socket, the logic coupled to the one or more substrates is to trigger a physical layer reset in one or more ports of the remote socket, set a frequency of the one or more ports to a target frequency specified in the transition request, and determine whether to trigger a training procedure in the one or more ports based on a first identifier associated with the remote socket and a second identifier associated with a peer socket coupled to the one or more ports.

Example 10 includes the semiconductor apparatus of Example 9, wherein the logic coupled to the one or more substrates is to trigger the training procedure on the one or more ports if the second identifier is greater than the first identifier.

Example 11 includes the semiconductor apparatus of Example 9, wherein the logic coupled to the one or more substrates is to bypass the training procedure on the one or more ports if the second identifier is less than the first identifier.

Example 12 includes the semiconductor apparatus of any one of Examples 8 to 11, wherein the logic coupled to the one or more substrates is to bypass a warm reset of the remote processor.

Example 13 includes the semiconductor apparatus of any one of Examples 8 to 11, wherein the indirect link is to include at least one of the plurality of peer sockets.

Example 14 includes the semiconductor apparatus of any one of Examples 8 to 11, wherein the logic coupled to the one or more substrates includes transistor channel regions that are positioned within the one or more substrates.

Example 15 includes at least one computer readable storage medium comprising a set of executable program instructions, which when executed by a remote processor coupled to a remote socket, cause the remote processor to detect, by the remote processor, a transition request from a system processor coupled to a system socket, wherein the system socket has an indirect link with the remote socket, and automatically conduct an operational speed transition at the remote socket in response to the transition request, wherein the operational speed transition at the remote socket is to occur in parallel with a plurality of operational speed transitions at a corresponding plurality of peer sockets.

Example 16 includes the at least one computer readable storage medium of Example 15, wherein to conduct the operational speed transition at the remote socket, execution of the instructions causes the remote processor to trigger a physical layer reset in one or more ports of the remote socket, set a frequency of the one or more ports to a target frequency specified in the transition request, and determine whether to trigger a training procedure in the one or more ports based on a first identifier associated with the remote socket and a second identifier associated with a peer socket coupled to the one or more ports.

Example 17 includes the at least one computer readable storage medium of Example 16, wherein the instructions, when executed, further cause the remote processor to trigger the training procedure on the one or more ports if the second identifier is greater than the first identifier.

Example 18 includes the at least one computer readable storage medium of Example 16, wherein the instructions, when executed, further cause the remote processor to bypass the training procedure on the one or more ports if the second identifier is less than the first identifier.

Example 19 includes the at least one computer readable storage medium of any one of Examples 15 to 18, wherein the instructions, when executed, further cause the remote processor to bypass a warm reset of the remote processor.

Example 20 includes the at least one computer readable storage medium of any one of Examples 15 to 18, wherein the indirect link is to include at least one of the plurality of peer sockets.

Example 21 includes a method of operating a performance-enhanced remote processor coupled to a remote socket, the method comprising detecting, by the remote processor, a transition request from a system processor coupled to a system socket, wherein the system socket has an indirect link with the remote socket, and automatically conducting an operational speed transition at the remote socket in response to the request, wherein the operational speed transition at the remote socket occurs in parallel with a plurality of operational speed transitions at a corresponding plurality of peer sockets.

Example 22 includes the method of Example 21, wherein conducting the operational speed transition at the remote socket includes triggering a physical layer reset in one or more ports of the remote socket, setting a frequency of the one or more ports to a target frequency specified in the transition request, and determining whether to trigger a training procedure in the one or more ports based on a first identifier associated with the remote socket and a second identifier associated with a peer socket coupled to the one or more ports.

Example 23 includes the method of Example 22, further including triggering the training procedure on the one or more ports if the second identifier is greater than the first identifier.

Example 24 includes the method of Example 22, further including bypassing the training procedure on the one or more ports if the second identifier is less than the first identifier.

Example 25 includes the method of any one of Examples 21 to 24, further including bypassing a warm reset of the remote processor.

Example 26 includes means for performing the method of any one of Examples 21 to 25.

Thus, technology described herein may eliminate warm resets on speed transitions, which reduces boot time. The technology also improves system performance and the customer usage experience. Additionally, the technology introduces a flow that may be executed in both boot time and runtime (e.g., operating system/OS environments), where the end user may switch the CPU ports to the supported speed (e.g., slow mode or the supported operational speeds) on demand. The technology therefore is beneficial in terms of performance improvement and power saving. Moreover, the technology described herein enables cloud service providers to use reconfigurability to adjust workload in a manner that provides better power efficiency. Furthermore, cloud service provides may use the technology to provide a better usage model of hardware partitioning with bare metal servers (e.g., single-tenant physical servers).

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

1-25. (canceled)

26. A performance-enhanced computing system comprising:
a plurality of peer sockets;
a remote socket;
a remote processor coupled to the remote socket;
a system socket having an indirect link with the remote socket;
a system processor coupled to the system socket, the system socket to issue a transition request to the remote socket via the indirect link; and
a memory comprising a set of executable program instructions, which when executed by the remote processor, cause the remote processor to:
detect the transition request from the system processor, and
automatically conduct an operational speed transition at the remote socket in response to the transition request, wherein the operational speed transition at the remote socket is to occur in parallel with a plurality of operational speed transitions at the plurality of peer sockets.

27. The computing system of claim 26, wherein to conduct the operational speed transition at the remote socket, execution of the instructions causes the remote processor to:
trigger a physical layer reset in one or more ports of the remote socket;
set a frequency of the one or more ports to a target frequency specified in the transition request; and
determine whether to trigger a training procedure in the one or more ports based on a first identifier associated with the remote socket and a second identifier associated with a peer socket coupled to the one or more ports.

28. The computing system of claim 2, wherein the instructions, when executed, further cause the remote processor to trigger the training procedure on the one or more ports if the second identifier is greater than the first identifier.

29. The computing system of claim 27, wherein the instructions, when executed, further cause the remote processor to bypass the training procedure on the one or more ports if the second identifier is less than the first identifier.

30. The computing system of claim 26, wherein the instructions, when executed, further cause the remote processor to bypass a warm reset of the remote processor.

31. The computing system of claim 26, wherein the indirect link includes at least one of the plurality of peer sockets.

32. The computing system of claim 26, wherein the system socket has a direct link with at least one of the plurality of peer sockets, and wherein the system processor is to issue the transition request to the at least one of the plurality of peer sockets via the direct link after issuance of the transition request to the remote socket via the indirect link.

33. A semiconductor apparatus comprising:
one or more substrates; and
logic coupled to the one or more substrates, wherein the logic is implemented at least partly in one or more of configurable logic or fixed-functionality hardware logic, the logic coupled to the one or more substrates to:
detect, by a remote processor coupled to a remote socket, a transition request from a system processor coupled to a system socket, wherein the system socket has an indirect link with the remote socket; and
automatically conduct an operational speed transition at the remote socket in response to the transition request, wherein the operational speed transition at the remote socket is to occur in parallel with a plurality of operational speed transitions at a corresponding plurality of peer sockets.

34. The semiconductor apparatus of claim 33, wherein to conduct the operational speed transition at the remote socket, the logic coupled to the one or more substrates is to:
trigger a physical layer reset in one or more ports of the remote socket;
set a frequency of the one or more ports to a target frequency specified in the transition request; and
determine whether to trigger a training procedure in the one or more ports based on a first identifier associated with the remote socket and a second identifier associated with a peer socket coupled to the one or more ports.

35. The semiconductor apparatus of claim 34, wherein the logic coupled to the one or more substrates is to trigger the training procedure on the one or more ports if the second identifier is greater than the first identifier.

36. The semiconductor apparatus of claim 34, wherein the logic coupled to the one or more substrates is to bypass the training procedure on the one or more ports if the second identifier is less than the first identifier.

37. The semiconductor apparatus of claim 33, wherein the logic coupled to the one or more substrates is to bypass a warm reset of the remote processor.

38. The semiconductor apparatus of claim 33, wherein the indirect link is to include at least one of the plurality of peer sockets.

39. The semiconductor apparatus of claim 33, wherein the logic coupled to the one or more substrates includes transistor channel regions that are positioned within the one or more substrates.

40. At least one computer readable storage medium comprising a set of executable program instructions, which when executed by a remote processor coupled to a remote socket, cause the remote processor to:
detect a transition request from a system processor coupled to a system socket, wherein the system socket has an indirect link with the remote socket; and
automatically conduct an operational speed transition at the remote socket in response to the transition request, wherein the operational speed transition at the remote socket is to occur in parallel with a plurality of operational speed transitions at a corresponding plurality of peer sockets.

41. The at least one computer readable storage medium of claim 40, wherein to conduct the operational speed transition at the remote socket, execution of the instructions causes the remote processor to:
trigger a physical layer reset in one or more ports of the remote socket;
set a frequency of the one or more ports to a target frequency specified in the transition request; and
determine whether to trigger a training procedure in the one or more ports based on a first identifier associated with the remote socket and a second identifier associated with a peer socket coupled to the one or more ports.

42. The at least one computer readable storage medium of claim 41, wherein the instructions, when executed, further cause the remote processor to trigger the training procedure on the one or more ports if the second identifier is greater than the first identifier.

43. The at least one computer readable storage medium of claim 41, wherein the instructions, when executed, further cause the remote processor to bypass the training procedure on the one or more ports if the second identifier is less than the first identifier.

44. The at least one computer readable storage medium of claim 40, wherein the instructions, when executed, further cause the remote processor to bypass a warm reset of the remote processor.

45. The at least one computer readable storage medium of claim 40, wherein the indirect link is to include at least one of the plurality of peer sockets.

46. A method of operating a performance-enhanced remote processor coupled to a remote socket, the method comprising:
detecting, by the remote processor, a transition request from a system processor coupled to a system socket, wherein the system socket has an indirect link with the remote socket; and
automatically conducting an operational speed transition at the remote socket in response to the request, wherein the operational speed transition at the remote socket occurs in parallel with a plurality of operational speed transitions at a corresponding plurality of peer sockets.

47. The method of claim 46, wherein conducting the operational speed transition at the remote socket includes:
triggering a physical layer reset in one or more ports of the remote socket;
setting a frequency of the one or more ports to a target frequency specified in the transition request; and
determining whether to trigger a training procedure in the one or more ports based on a first identifier associated with the remote socket and a second identifier associated with a peer socket coupled to the one or more ports.

48. The method of claim 47, further including triggering the training procedure on the one or more ports if the second identifier is greater than the first identifier.

49. The method of claim 47, further including bypassing the training procedure on the one or more ports if the second identifier is less than the first identifier.

50. The method of claim 46, further including bypassing a warm reset of the remote processor.
